(19) United States
(12) Patent Application Publication
(10) Pub. No.: US 2015/0155813 A1
(43) Pub. Date: Jun. 4, 2015

(54) MOTOR DRIVING APPARATUS AND MOTOR DRIVING METHOD

(71) Applicant: SAMSUNG ELECTRO-MECHANICS CO., LTD., Suwon-Si (KR)

(72) Inventors: Kyeoung Hun PARK, Suwon-Si (KR); Geun Hong LEE, Suwon-Si (KR); Han Tae KIM, Suwon-Si (KR)

(21) Appl. No.: 14/502,497

(22) Filed: Sep. 30, 2014

(30) Foreign Application Priority Data
Dec. 3, 2013 (KR) 10-2013-0149408

(51) Int. Cl. H02P 23/00

(52) U.S. Cl. CPC H02P 23/0095

(57) ABSTRACT

A motor driving apparatus having a protection function for protecting an inverter or a controller from a back electromotive voltage may include: a driving unit including at least one inverter arm switching driving power to drive a motor; a first switching unit forming a transfer path through which a back electromotive voltage from the motor is transferred to a charging unit; and a second switching unit including at least one switch positioned between a driving line of the driving unit and the motor and turned on and off at a preset interval to decrease a voltage level of the back electromotive voltage from the motor.

### CROSS-REFERENCE TO RELATED APPLICATION

This application claims the benefit of Korean Patent Application No. 10-2013-0149408 filed on Dec. 3, 2013, with the Korean Intellectual Property Office, the disclosure of which is incorporated herein by reference.

### BACKGROUND

The present disclosure relates to a motor driving apparatus and a motor driving method.

Recently, in accordance with the rapid development of motor technology (electric motors) and the power electronics field using the same, the size of motors in systems using such motors has gradually decreased.

As this motor, a permanent magnet motor has high efficiency, high performance, and very high output density per unit volume, such that it may be usefully manufactured while having a small size and being lightweight.

However, in the case in which the permanent magnet motor is used in a system using low voltage power of 60V or less, back electromotive voltage generated in the permanent magnet motor at the time of high speed driving of 6000 rpm or more may increase to be much higher than a power supply voltage. Therefore, an induction type motor, a winding type synchronous motor, a claw pole type motor, or the like, may be mainly used in the system using the power of the low voltage.

That is, in the case of the permanent magnet motor, when an inverter and a controller are abnormally operated, back electromotive voltage from a permanent magnet is introduced into the inverter or the controller as it is, such that an entire system may be abnormally operated.

The following Related Art Document suggests a protection function operation in a motor driving apparatus, but does not disclose a protection function for protecting an inverter or a controller from back electromotive voltage generated in a motor.

### RELATED ART DOCUMENT

(Patent Document 1) Korean Patent Laid-Open Publication No. 2010-0044416

### SUMMARY

An exemplary embodiment in the present disclosure may provide a motor driving apparatus having a protection function for protecting an inverter or a controller from a back electromotive voltage, and a motor driving method.

According to an exemplary embodiment in the present disclosure, a motor driving apparatus may include: a driving unit including at least one inverter arm switching driving power to drive a motor; a first switching unit forming a transfer path through which back electromotive voltage from the motor is transferred to a charging unit; and a second switching unit including at least one switch positioned between a driving line of the driving unit and the motor and turned on and off at a preset interval to decrease a voltage level of the back electromotive voltage from the motor.

The driving unit may include three-phase inverter arms.

The second switching unit may include first and second switches each positioned in two-phase driving lines among three-phase driving lines from the driving unit.

The first and second switches may be turned on and off at the preset interval for a preset period of time when the back electromotive voltage is generated by the motor and be turned off after the preset period of time.

The first and second switches may be repeatedly turned on and off at the preset interval for a preset period of time when the voltage level of the back electromotive voltage from the motor is equal to a preset reference voltage level or higher after the transfer path of the first switching unit is formed, thereby decreasing the voltage level of the back electromotive voltage from the motor.

The motor may be a permanent magnet motor.

The first switching unit may be turned on when the back electromotive voltage is generated by the motor, thereby forming the transfer path through which the back electromotive voltage is transferred to the charging unit, and the second switching unit may be repeatedly turned on and off when the voltage level of the back electromotive voltage is equal to a preset reference voltage level or higher, thereby decreasing the voltage level of the back electromotive voltage.

The second switching unit may be turned off when the voltage level of the back electromotive voltage is equal to the preset reference voltage or higher for a preset period of time, thereby blocking the transfer of the back electromotive voltage.

According to an exemplary embodiment in the present disclosure, a motor driving method may include: a first protecting step of turning a first switching unit on when back electromotive voltage is generated by a motor, thereby forming a transfer path through which the back electromotive voltage is transferred to a charging unit charged with power; and a second protecting step of repeatedly turning at least one switch positioned between a driving line of a driving unit driving the motor and the motor on and off at a preset interval when a voltage level of the back electromotive voltage is equal to a preset reference voltage level or higher, thereby decreasing the voltage level of the back electromotive voltage.

The motor driving method may further include a third protecting step of maintaining the at least one switch in a turned-off state when the voltage level of the back electromotive voltage is equal to the preset reference voltage or higher after repeatedly turning the at least one switch on and off at the preset interval for a preset period of time in the second protecting step.

The motor may be a three-phase permanent magnet motor.

In the second protecting step, signal transfer paths of two-phase driving lines among three-phase driving lines transferring driving signals driving the motor to the motor may be turned on and off.

### BRIEF DESCRIPTION OF DRAWINGS

The above and other aspects, features and other advantages in the present disclosure will be more clearly understood from the following detailed description taken in conjunction with the accompanying drawings, in which:

FIG. 1 is a circuit diagram schematically illustrating a motor driving apparatus according to an exemplary embodiment in the present disclosure;

FIG. 2 is a circuit diagram schematically illustrating an operation of a first switching unit of the motor driving apparatus according to an exemplary embodiment in the present disclosure;

FIG. 3 is an operation flow chart schematically illustrating a motor driving method according to an exemplary embodiment in the present disclosure;

FIG. 4 is a graph illustrating back electromotive voltage applied from a motor; and

FIG. 5 is a graph illustrating that a voltage level of the back electromotive voltage is decreased by a second switching unit of the motor driving apparatus according to an exemplary embodiment in the present disclosure.

### DETAILED DESCRIPTION

Exemplary embodiments in the present disclosure will now be described in detail with reference to the accompanying drawings.

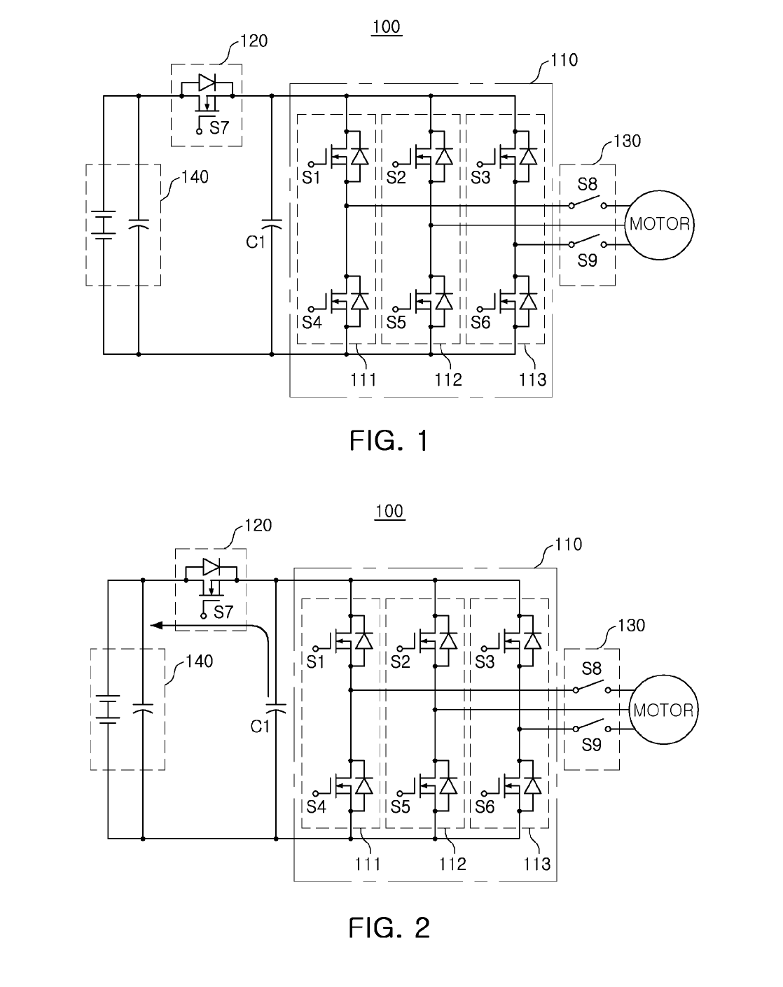

FIG. 1 is a circuit diagram schematically illustrating a motor driving apparatus according to an exemplary embodiment in the present disclosure; and FIG. 2 is a circuit diagram schematically illustrating an operation of a first switching unit of the motor driving apparatus according to an exemplary embodiment in the present disclosure.

Referring to FIG. 1, a motor driving apparatus 100 according to an exemplary embodiment in the present disclosure may include a driving unit 110, a first switching unit 120, and a second switching unit 130.

The driving unit 110 may include at least one inverter arm, which may include two switches connected to each other in series, and a driving line may be formed from a connection point between the two switches to a motor to transfer a driving signal driving the motor to the motor.

In an exemplary embodiment in the present disclosure, the driving unit 110 may include three-phase inverter arms 111 to 113, and each of first to third inverter arms 111 to 113 may include two driving switches S1 and S4, S2 and S5, and S3 and S6 connected to each other in series between both ends to which driving power is applied.

First, the motor may receive the driving power from the outside to perform a rotation operation depending on pulse width modulation (PWM) signals.

For example, magnetic fields may be generated in the respective coils of the motor by a driving current provided by the driving unit 110.

A rotor included in the motor may be rotated by the magnetic fields generated in these coils.

The driving unit 110 may provide the PWM signals to the motor to control the driving of the motor.

The driving unit 110 may detect a zero-crossing point in time of back electromotive force of the motor to determine a phase converting point in time of the motor M.

In addition, the driving unit 110 may provide PWM signals in which the phase converting point in time is reflected to the motor to control the driving of the motor.

The driving unit 110 may convert a direct current (DC) voltage into a single-phase or a plural-phase (for example, a three-phase or a four-phase) voltage depending on the PWM signals and apply the converted voltage to each of the coils (corresponding to the plural phases) of the motor M to generate the magnetic fields.

The driving unit 110 may apply the single-phase voltage or sequentially apply phase voltages to plural phases to allow the rotor of the motor to be rotated.

For example, when it is assumed that a stator of the motor is a permanent magnet having a polarity and the rotor has three coils, the driving unit 110 may include the first to third inverter arms 111 to 113 and sequentially apply the phase voltages to the three coils (three phases) of the rotor from the first to third inverter arms 111 to 113 through the driving line to generate the magnetic fields.

Therefore, the rotor has a predetermined polarity through the generated magnetic fields and the respective phases also sequentially have a polarity, such that the rotor may be rotated around the stator.

Meanwhile, a start of the motor fails due to external impact, fault, or the like, such that the driving unit 110 may not be normally operated. In this case, the motor is continuously rotated, such that back electromotive voltage generated by the motor may be applied to the driving unit 110, a controller (not shown) providing the PWM signals to the first to third inverter arms 111 to 113 of the driving unit 110, or the like.

To this end, the first switching unit 120 may include a switch S7, which may be positioned between a charging unit 140 that may be charged with DC power and the driving unit 110 and be turned on to form a transfer path so that the back electromotive voltage generated by the motor is applied to the charging unit 140, as shown by an arrow in FIG. 2.

In addition, the second switching unit 130 may include at least one switch, which may be formed on the driving line between the inverter arm of the driving unit and the motor.

According to an exemplary embodiment in the present disclosure, the driving unit 110 may include the first to third inverter arms 111 to 113, and the second switching unit 130 may include first and second switches S8 and S9 each formed in two-phase driving lines among three-phase driving lines between the first to third inverter arms and the motor.

The first and second switches S8 and S9 of the second switching unit 130 may be repeatedly turned on and off to decrease a voltage level of the back electromotive voltage generated by the motor.

The repeated turning-on and turning-off operations of the first and second switches S8 and S9 of the second switching unit 130 may be performed in the case in which the voltage level of the back electromotive voltage generated by the motor is equal to a preset reference voltage level or higher after a turn-on operation of the switch S7 of the first switching unit 120, and the first and second switches S8 and S9 may be turned off in the case in which the voltage level of the back electromotive voltage generated by the motor is the preset reference voltage level or more after the repeated turning-on and turning-off operations of the first and second switches S8 and S9 are performed for a preset period of time, thereby blocking the back electromotive voltage generated by the motor from being applied to the driving unit 110.

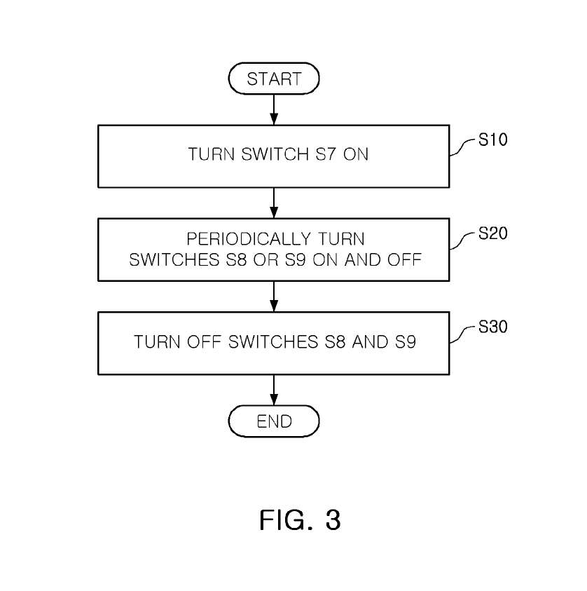

FIG. 3 is an operation flow chart schematically illustrating a motor driving method according to an exemplary embodiment in the present disclosure.

Referring to FIG. 3 together with FIG. 1, the back electromotive voltage generated by the motor may be first applied to the driving unit 110 in the case in which the start of the motor fails due to an abnormal operation of the driving unit 110.

In this case, the switch S7 of the first switching unit 120 may be turned on to form the transfer path so that the back electromotive voltage applied to the driving unit 110 is applied to the charging unit 140 (S10).

Next, the voltage level of the back electromotive voltage generated by the motor may be the preset reference voltage level or more after a predetermined time elapses after the switch S7 of the first switching unit 120 is turned on.

In this case, the first and second switches S8 and S9 of the second switching unit 130 may be repeatedly turned on and off at a preset interval to decrease the voltage level of the back electromotive voltage generated by the motor (S20).

Finally, in the case in which the voltage level of the back electromotive voltage generated by the motor is the preset reference voltage level or more even after the turning-on and turning-off operations of the first and second switches S8 and S9 of the second switching unit 130 are repeated and the preset period of time elapses, the first and second switches S8 and S9 may be turned off to block the back electromotive voltage generated by the motor from being applied to the driving unit 110 (S30).

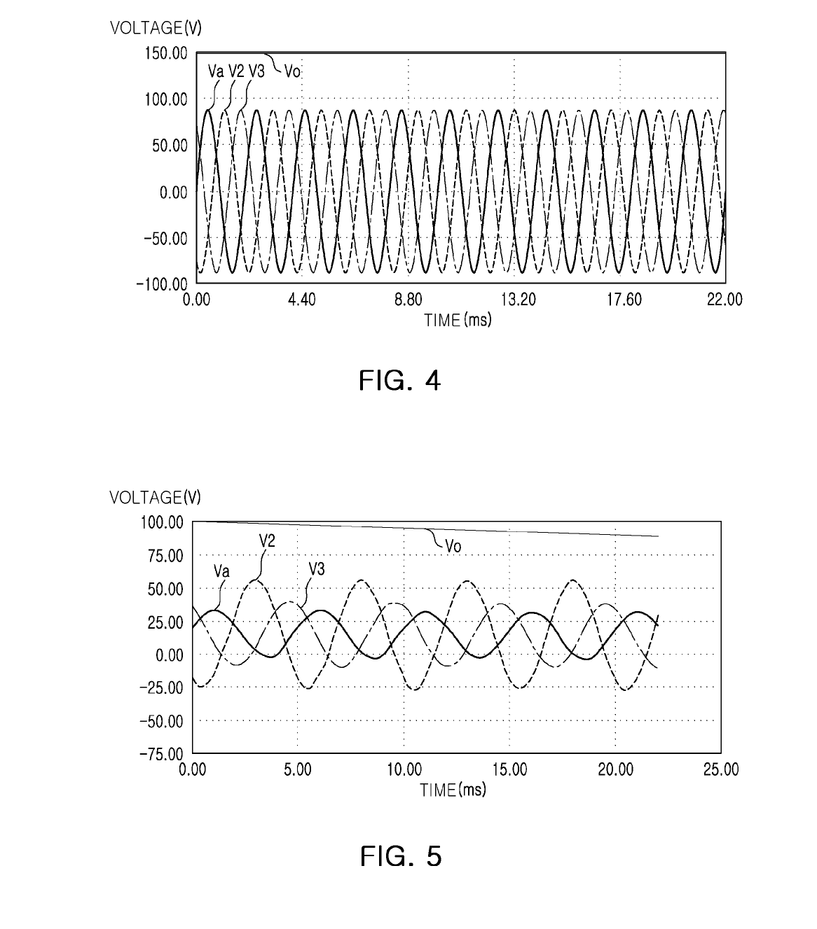

FIG. 4 is a graph illustrating a back electromotive voltage applied from a motor; and FIG. 5 is a graph illustrating that a voltage level of the back electromotive voltage is decreased by a second switching unit of the motor driving apparatus according to an exemplary embodiment in the present disclosure.

As shown in FIG. 4, a voltage level of a back electromotive voltage that may be generated by the motor when the start of the motor fails may be seen.

As shown in FIG. 4, a back electromotive voltage of, for example, 100V p-p may be generated.

Referring to FIG. 5, it may be seen that in the case in which the first and second switches S8 and S9 of the second switching unit 130 are repeatedly turned on and off at the preset interval, the voltage level of the back electromotive voltage that may be generated by the motor when the start of the motor fails is decreased.

As shown in FIG. 5, it may be seen that in the case in which the back electromotive voltage of, for example, 100V p-p is generated, the voltage level of the back electromotive voltage is decreased to about 90V p-p.

As set forth above, according to an exemplary embodiment in the present disclosure, the inverter and the controller may be protected from the back electromotive voltage introduced from the motor at the time of an abnormal operation of the inverter.

While exemplary embodiments have been shown and described above, it will be apparent to those skilled in the art that modifications and variations could be made without departing from the scope of the present invention as defined by the appended claims.

What is claimed is:

1. A motor driving apparatus comprising:
a driving unit including at least one inverter arm switching driving power to drive a motor;
a first switching unit forming a transfer path to transfer a back electromotive voltage from the motor to a charging unit; and
a second switching unit including at least one switch positioned between a driving line of the driving unit and the motor and turned on and off at a preset interval to decrease a voltage level of the back electromotive voltage from the motor.

2. The motor driving apparatus of claim 1, wherein the driving unit includes three-phase inverter arms.

3. The motor driving apparatus of claim 2, wherein the second switching unit includes first and second switches each positioned in two-phase driving lines among three-phase driving lines from the driving unit.

4. The motor driving apparatus of claim 3, wherein the first and second switches are turned on and off at the preset interval for a preset period of time when the back electromotive voltage is generated by the motor and are turned off after the preset period of time.

5. The motor driving apparatus of claim 3, wherein the first and second switches are repeatedly turned on and off at the preset interval for a preset period of time when the voltage level of the back electromotive voltage from the motor is equal to a preset reference voltage level or higher after the transfer path of the first switching unit is formed, thereby decreasing the voltage level of the back electromotive voltage from the motor.

6. The motor driving apparatus of claim 1, wherein the motor is a permanent magnet motor.

7. The motor driving apparatus of claim 1, wherein the first switching unit is turned on when the back electromotive voltage is generated by the motor, thereby forming the transfer path through which the back electromotive voltage is transferred to the charging unit, and
the second switching unit is repeatedly turned on and off when the voltage level of the back electromotive voltage is equal to a preset reference voltage level or higher, thereby decreasing the voltage level of the back electromotive voltage.

8. The motor driving apparatus of claim 7, wherein the second switching unit is turned off when the voltage level of the back electromotive voltage is equal to the preset reference voltage or higher for a preset period of time, thereby blocking the transfer of the back electromotive voltage.

9. A motor driving method comprising:
a first protecting step of turning a first switching unit on when a back electromotive voltage is generated by a motor, thereby forming a transfer path through which the back electromotive voltage is transferred to a charging unit charged with power; and
a second protecting step of repeatedly turning at least one switch positioned between a driving line of a driving unit driving the motor and the motor on and off at a preset interval when a voltage level of the back electromotive voltage is equal to a preset reference voltage level or higher, thereby decreasing the voltage level of the back electromotive voltage.

10. The motor driving method of claim 9, further comprising a third protecting step of maintaining the at least one switch in a turned-off state when the voltage level of the back electromotive voltage is equal to the preset reference voltage or higher after repeatedly turning the at least one switch on and off at the preset interval for a preset period of time in the second protecting step.

11. The motor driving method of claim 9, wherein the motor is a three-phase permanent magnet motor.

12. The motor driving method of claim 11, wherein in the second protecting step, signal transfer paths of two-phase driving lines among three-phase driving lines transferring driving signals driving the motor to the motor are turned on and off.
